(19) United States
(12) Patent Application Publication
(10) Pub. No.: US 2010/0063169 A1
(43) Pub. Date: Mar. 11, 2010

(54) PHOSPHORAMIDE ESTER FLAME RETARDANT AND RESINS CONTAINING SAME

(76) Inventors: Jeffrey Stowell, Wingdale, NY (US); Weihong Liu, Bridgewater, NJ (US)

Correspondence Address: DILWORTH & BARRESE, LLP, 1000 WOODBURY ROAD, SUITE 405, WOODBURY, NY, 11797, US

(21) Appl. No.: 12/522,079

(22) PCT Filed: Jan. 4, 2008
(86) PCT No.: PCT/US2008/000174

§ 371 Date: Nov. 9, 2009

Related U.S. Application Data
(60) Provisional application No. 60/878,597, filed on Jan. 4, 2007.

(51) Int. Cl. C09K 21/12; C07F 9/08; C08K 5/51

(52) U.S. Cl. 521/55; 558/84; 252/601; 524/108

(57) ABSTRACT

Certain cyclic phosphoramide ester compounds useful, inter alia, as halogen-free flame-retardant compounds, are disclosed. The compounds are particularly useful for providing flame retarded polyurethane foams. (I)

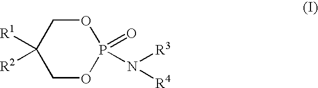

### FIELD OF THE INVENTION

This invention relates to cyclic phosphoramide esters and their use as flame retardants in synthetic resins such as polyurethane foams.

### BACKGROUND OF THE INVENTION

Many kinds of synthetic organic resins are combustible to one extent or another, some more than others. Where their potential for combustion possesses heightened safety and/or health risks, it is a general practice to add one or a mixture of flame retardants to such resins.

Flexible polyurethane foams are widely used as cushioning or padding materials, for example, in furniture and in automobiles, and it is known to incorporate fire-retardant additives in such foams. However, there are often considerable technical problems and toxicological concerns restricting the use of these flame retardants as is the case with conventional halogenated fire retardants.

Flame-retardant additives commonly used to make flame retarded polyurethane foams typically contain halogen compounds. However, for reasons of product sustainability there is a movement within the industry towards the use of non halogen-containing flame retardants.

Phosphates are known for incorporation in synthetic resins such as polyurethane foams where they function as flame retardants. It has now been discovered that certain novel cyclic phosphoramide esters alone, or in combination with one or more other flame retardants, incorporated into polyurethane and polyisocyanurate foam results in flame retardant foam capable of meeting a variety of flame retardancy standards without the presence of halogen atoms.

### SUMMARY OF THE INVENTION

The present invention provides a cyclic phosphoramide compound of the formula:

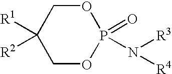

wherein, R¹ and R² are straight-chain or branched alkyl groups having from 1 to 6 carbon atoms, which optionally contains one or more non-terminal heteroatom substituents, R³ and R⁴ are independently either a hydrogen atom, aryl or substituted aryl group, or a straight-chain or branched alkyl groups having from 1 to 6 carbon atoms, which optionally contains one or more non-terminal heteroatom substituents.

### DETAILED DESCRIPTION OF THE INVENTION

This invention is directed to certain cyclic phosphoramide ester compounds which are particularly useful as halogen-free flame-retardant materials in flame retardant-effective amounts to any of a wide variety of resins to impart flame retardant properties thereto.

The novel cyclic phosphoramide esters of this invention are satisfactorily employed by themselves and, if desired, in combination with one or more other flame retardants, e.g., one or more organohalogen, oranophosphorous and/or melamine-based flame retardants as described, e.g., in U.S. Pat. No. 6,967,252. Melamine-based flame retardants as used herein includes melamine compounds, melamine per se, i.e., the compound 2,4,6-triamino s-triazine, and its flame retardant-effective derivatives.

In accordance with the present invention, it has unexpectedly been found that a mixture of an effective flame-retardant amount of a novel non-halogen neopentyl phosphoramide ester and a melamine compound incorporated into a polyurethane foam composition results in flame retarded foam capable of meeting a variety of flame retardancy standards, e.g., the California Technical Bulletin 117 test criteria, the Motor Vehicle Safety Standard 302 (MVSS 302) test criteria, and the stringent British Standard 5852 (BS 5852) test criteria.

The cyclic phosphoramide ester of the present invention is represented by the general formula:

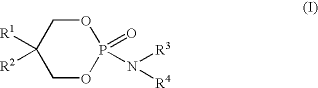

In the formula (I), R¹ and R² have 1 to 6 carbon atoms, which optionally contain heteroatom substituents, e.g., O, N, S, and the like, and can be straight-chain or branched alkyl groups, examples of which include straight-chain alkyl groups such as methyl, ethyl, n-propyl, n-butyl, n-pentyl, n-hexyl, etc., and branched alkyl groups such as iso-propyl, iso-butyl, sec-butyl, tert-butyl, iso-pentyl, tert-pentyl, neo-pentyl, iso-hexyl, and the like. Among these groups, straight-chain or branched alkyl groups having a carbon number of 1 to 4 are preferable, and methyl is the most preferable.

R³ and R⁴ are independently either a hydrogen atom, aryl or substituted aryl group, or a straight-chain or branched alkyl groups having from 1 to 6 carbon atoms, which may or may not contain additional heteroatom substituents, e.g., methyl, ethyl, n-propyl, n-butyl, n-pentyl, n-hexyl, iso-propyl, iso-butyl, sec-butyl, tert-butyl, iso-pentyl, tert-pentyl, neo-pentyl, and iso-hexyl, hydroxyethyl, hydroxypropyl, hydroxybutyl, 2-aminoethyl, N,N-diethyl-2-aminoethyl, ethylene thiol and the like.

Specific examples of phosphoramide esters in accordance with the invention include the following: cyclic neopentyl N-propyl phosphoramide, cyclic neopentyl N-isopropyl phosphoramide, cyclic neopentyl N-ethyl phosphoramide, cyclic neopentyl N-methyl phosphoramide, cyclic neopentyl N,N-dipropyl phosphoramide, cyclic neopentyl N,N-diisopropyl phosphoramide, cyclic neopentyl N,N-diethyl phosphoramide, cyclic neopentyl N,N-dimethyl phosphoramide, and cyclic neopentyl N-phenyl phosphoramide.

According to one specific embodiment of the invention, the cyclic phosphoramide of the invention has the following formula:

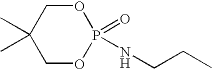

Other cyclic phosphoramides of the invention include:

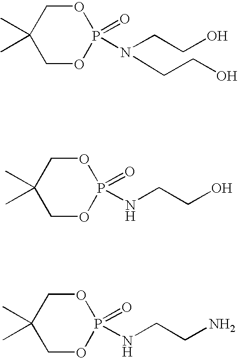

The novel phosphoramide esters of the present invention can be prepared by reacting, at least one trichlorophosphate with at least one disubstituted propylene glycol of the general formula:

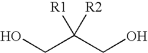

wherein R1 and R2 are as defined above, in at least the stochiometrically required amounts (e.g., at least 1 mole of trichlorophosphate per mole of neopentyl glycol), to provide chlorophosphate, then adding at least one alkyl or aryl amine in at least the stochiometrically required amounts, e.g., at least 1 mole of the amine per mole of the chlorophosphate, to the reactor to finish the reaction.

A general reaction sequence of the synthesis of the novel phosphoramide esters of the present invention is illustrated as follows:

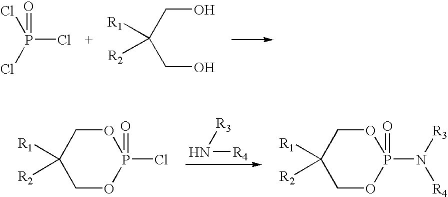

The phosphoramide esters of the invention can be added in flame retardant-effective amounts to any of a wide variety of resins to impart flame retardant properties thereto. Resins to which the phosphoramide esters can be added include, e.g., polyolefins such as polyethylene, polypropylene and polyethylene-co-propylene copolymer, polyvinyl chloride, polystyrene, polyacrylates, polymethacrylates, polycarbonates, polyesters, polyurethanes, and the like, blends of resins, as well as many other kinds of resins as described, e.g., in U.S. Pat. No. 6,967,252, the entire contents of which are incorporated by reference herein.

The phosphoramide esters of this invention are satisfactorily employed by themselves and, if desired, in combination with one or more other flame retardants, e.g., any of the organohalogen, organophosphorus, inorganic compounds and/or melamine-based flame retardants as described in, e.g., the aforementioned U.S. Pat. No. 6,967,252 and in U.S. Patent Application 2006/0208238, the contents of which are also incorporated by reference herein.

Suitable organophosphorus-based flame retardants that can be used with the phosphoramide esters of this invention include, but are not limited to, triethyl phosphate, ethyl diphenyl phosphate, dibutyl phenyl phosphate, butyl diphenyl phosphate, 2-ethylhexyl diphenyl phosphate, triphenyl phosphate, tricresyl phosphate, alkylated triaryl phosphates, such as butylated or isopropylated triphenyl phosphate, dimethyl methylphosphonate, dimethyl propylphosphonate and the like and mixtures thereof. Examples of organohalogen-based flame retardants suitable for use with the phosphoramide esters of the present invsntion include, e.g., tris(chloropropyl) phosphate and tris(dichloroisopropyl) phosphate, N-trifluoromethylmelamine, N-(2-chloroethyl)melamine, N-(3-bromophenyl)melamine and the like and mixtures thereof.

Examples of melamine-based flame retardants that can be used with the phosphoramide esters of this invention include, but are not limited to, melamine, N-methylmelamine, N-cyclohexylmelamine, N-phenylmelamine, N,N-dimethylmelamine, N,N-diethylmelamine, N,N-dipropylmelamine, N,N′-dimethylmelamine, N,N′,N″-trimethylmelamine, and the like. Also alcohol derivatives of melamine such as trimethylolmelamine or triethylolmelamine may be used. Melamine sulfate and melamine phosphates such as melamine orthophosphate, melamine polyphosphate, and dimelamine orthophosphate may also be used.

The phosphoramide ester flame retardants of the invention can be added to the host resin(s) employing any suitable procedure, e.g., utilizing an extruder or roll-type blender in the case of a thermoplastic resin and adding the flame retardant(s) to a thermoset resin-forming reaction mixture or component thereof in the case of a thermoset resin.

The flame retardant performance of polyurethane foams and polyisocyanurate foams can be significantly improved by the addition of one or more phosphoramide esters of this invention, with or without other flame retardant (s) such as those aforementioned. The flame retardant(s) can be introduced into these foams via the reaction mixtures from which the foams are produced. Typically, a polyurethane foam or polyisocyanurate foam-forming reaction mixture contains one or more polyols, e.g., polyether polyol or polyester polyol, polyisocyanates, chain extenders, silicone surfactants, blowing agents, catalysts and, if desired, other similarly known and conventional components.

The phosphoramide ester flame retardants of the invention can be reactive phosphate flame retardant(s), i.e., those in which R¹, R², R³ or R⁴ can contain chemically reactive groups, e.g., hydroxyl, thiol or primary/secondary amine groups, the flame retardants will be chemically incorporated within the structure of the resulting foam. This chemical incorporation can be achieved by simply adding the reactive phosphoramide ester(s) to the resin-forming components mentioned above or to its polyol component.

The flame retardant(s) of the present invention can be non-reactive and any other non-reactive flame retardant(s) that may be utilized herein will be substantially uniformly incorporated into, and mechanically entrained within, the resulting foam.

In contrast to the non-reactive phosphoramide ester flame retardants, reactive phosphoramide flame retardant(s) will be chemically incorporated within the structure of the resulting foam. This chemical incorporation can be achieved by first reacting polyol, polyisocyanate and reactive phosphoramide ester(s) to provide a hydroxyl-terminated or isocyanate-terminate polyurethane prepolymer from which the polyurethane foam (or non-cellular polyurethane resin) is ultimately derived and/or to simply add the reactive phosphoramide ester(s) to the resin-forming components mentioned above or to its polyol component.

It is, of course, contemplated that both non-reactive and reactive phosphoramide ester flame retardant can be incorporated in a polyurethane foam or polyisocyanurate foam with the non-reactive flame retardant being mechanically entrained therein and the reactive flame retardant being chemically integrated in the foam structure.

The amounts of flame retardant(s) introduced into a resin or resin blend can vary widely provided that at least a flame retardant-effective amount is utilized. For many resins including those mentioned, the total amount of flame retardant (i.e., phosphoramide ester flame retardant(s) of this invention alone or in combination with one or more other flame retardants) can vary from about 0.5 to about 45 weight percent of the resin(s), preferably from about 3 to about 40 weight percent of the resin(s) and more preferably from about 5 to about 35 weight percent of the resin(s). Optimum amounts of specific flame retardant(s) for a specific resinous composition can be readily determined employing known and conventional procedures.

The advantages of this invention are illustrated by the following examples. The reactants, proportions and other specific conditions are presented as being typical and should not be construed to limit the invention unduly.

### EXAMPLES

Flame-retarded polyurethane foam Example 1 and Comparative Examples 1 and 2 were hand mixed laboratory pours made in a box (free rise). The components of the formulation used to prepare Example 1 and Comparative Examples 1 and 2 are identified in Table 1 below, shown as parts by weight in relation to 100 parts by weight of the polyol. Comparative Example 2 was prepared as a non-flame retardant foam.

TABLE 1

| ADDITIVE | ADDITION LEVEL |
|---|---|
| Vorinol 3136 (polyether polyol | 100 |
| with an OH number of 54 | |
| available from Dow Chemical) | |
| FR (Phosphoramide and | 13 |
| Phosphate prepared by | |
| Supresta, LLC) | |
| Melamine (Melamine 003 | 18 |
| Grade available from DSM) | |
| H₂O | 3.55 |
| D33LV/A-1: 3/1 ratio (Dabco | 0.23 |
| BLV catalyst available from | |
| Air Products) | |
| Silicone L-620 (Niax Silicone | 0.80 |
| L-620 from General Electric | |
| Advanced Materials) | |
| Stannous Octoate T-10 (Dabco | 0.55 |
| T-10 available from Air | |
| Products) | |
| TDI (Mondur TD-80 Grade A | 47.33 |
| available from Bayer Material | |
| Science) | |
| TDI Index | 110 |

The novel cyclic neopentyl N-propyl phosphoramide (NPPA) flame retardant of Example 1 was prepared as follows: 612 g (4 mol) of POCl₃ was placed in a reactor with an agitator, a thermometer, a nitrogen inlet, and a condenser connected to a scrubber as a nitrogen outlet. The scrubber was also connected to a vacuum system (water-pump). The reactor was cooled to 5° C., and 416 g (4 mol) of neopentyl glycol was added to the reactor in four equal 1 mol additions within a 4 hour period. The temperature of the reactor was allowed to rise to about 50° C. after each addition. The reactor temperature was never allowed to exceed 50° C. After the 4 hour period, reactor cooling was stopped, and the reactor temperature was allowed to increase on its own to 50° C. within 1 hour, at which time the reaction solidified. The reactor was heated to 100° C. to melt the solid, after which vacuum was applied to the reactor to help remove any dissolved HCl in the reaction liquid. After removing the residual HCl, 500 ml of toluene was added to the reactor. After cooling the reactor to 10° C., 472.9 g (8.0 mol) of propylamine was added dropwise within 1 hour. The reaction temperature was controlled below 35° C. After finishing the propylamine addition, the reactor was heated to 80° C. and held for 1 hour. After cooling the reactor to room temperature and removing the propylamine-HCl salt, the product was washed with 100 ml of aqueous NaOH (5%) and 100 ml of water to further remove any remaining salt. Toluene and any remaining water were removed with a rotary evaporator at 50° C. under vacuum.

Example 1 and Comparative Examples 1 and 2 were tested using a non-certified reduced-scale version of the British Standard 5852 (BS 5852) Supresta LLC developed for the specific purpose of screening new product candidates using less foam than required by the normal BS 5852. The reduced-scale test is run using foam samples that measured 11″33 11″×3″ for back and 11″×8″×3″ for bottom. The ignition source used was a Crib #4 (8.5 grams) and the reagent was isopropyl alcohol (1.4 ml).

As presented in Table 2, the cured polyurethane foam of Example 1 and Comparative Examples 1 and 2 (Comparative Example 2 contained no flame-retardant compounds) included the following flame-retardant materials: cyclic neopentyl N-propyl phosphoramide (NPPA); tris (chloropropyl) phosphate (TCPP); and melamine (obtained from the DSM Co. 99% having a particle size of 40 microns), respectively.

TABLE 2

| | | Comparative | |
|---|---|---|---|
| | Example 1: | Example 1: | Comparative |
| | NPPA/melamine | TCPP/melamine | Example 2: |
| FR | 13 | 13 | 0 |
| Melamine | 18 | 18 | 0 |
| Small Scale BS | 16 | 9 | |
| 5852 | | | |
| Weight Loss in | | | |
| grams | | | |
| % Weight Loss | 5% | 3% | EM* |

*Extinguished manually

The foam containing the 13/18 blend of non-halogen flame-retardant mixture of cyclic neopentyl N-propyl phosphoramide and melamine showed a significant improvement in weight lost over the non-flame retardant foam Comparative Example 2 (which had to be manually extinguished after >50% weight loss), with an overall weight loss comparable to that observed for the TCPP/melamine foam.

While the process of the invention has been described with reference to certain embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out the process of the invention but that the invention will include all embodiments falling within the scope of the appended claims.

1. A phosphoramide compound of the general formula: 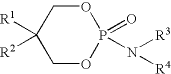
wherein, R¹ and R² are straight-chain or branched alkyl groups having from 1 to 6 carbon atoms, which optionally contains one or more non-terminal heteroatom substituents, R³ and R⁴ are independently either a hydrogen atom, aryl or substituted aryl group, or a straight-chain or branched alkyl groups having from 1 to 6 carbon atoms, which optionally contains one or more non-terminal heteroatom substituents.

2. The phosphoramide of claim 1 wherein any heteroatoms in R¹, R², R³ and R⁴ are selected from the group consisting of O, S and N.

3. The phosphoramide of claim 1 wherein R¹ and R² are straight-chain or branched alkyl groups having from 1 to 4 carbon atoms, which optionally contains one or more non-terminal heteroatom substituents.

4. The phosphoramide of claim 1 wherein R¹ and R² are independently selected from the group consisting of methyl, ethyl, n-propyl, n-butyl, n-pentyl, n-hexyl, iso-propyl, iso-butyl, sec-butyl, tert-butyl, iso-pentyl, tert-pentyl, neo-pentyl, and iso-hexyl, which optionally contains one or more non-terminal heteroatom substituents.

5. The phosphoramide of claim 1 wherein R³ and R⁴ are independently selected from the group consisting of methyl, ethyl, n-propyl, n-butyl, n-pentyl, n-hexyl, iso-propyl, iso-butyl, sec-butyl, tert-butyl, iso-pentyl, tert-pentyl, neo-pentyl, iso-hexyl, hydroxyethyl, hydroxypropyl, hydroxybutyl, 2-aminoethyl, N,N-diethyl-2-aminoethyl, and ethylene thiol, which optionally contains one or more non-terminal heteroatom substituents.

6. The phosphoramide of claim 1 wherein R¹ and R² are methyl.

7. A phosphoramide of claim 1 selected from the group consisting of the cyclic neopentyl N-propyl phosphoramide, cyclic neopentyl N-isopropyl phosphoramide, cyclic neopentyl N-ethyl phosphoramide, cyclic neopentyl N-methyl phosphoramide, cyclic neopentyl N,N-dipropyl phosphoramide, cyclic neopentyl N,N-diisopropyl phosphoramide, cyclic neopentyl N,N-diethyl phosphoramide, cyclic neopentyl N,N-dimethyl phosphoramide, cyclic neopentyl N-phenyl phosphoramide.

8. A flame retardant composition comprising at least one phosphoramide of claim 1.

9. The flame retardant composition of claim 8 further comprising at least one different flame retardant.

10. The flame retardant composition of claim 9 wherein the different flame retardant is at least one member selected from the group consisting of organohalogen compound, organophosphorus compound and melamine compound.

11. The flame retardant composition of claim 9 wherein the phosphoramide is cyclic neopentyl N-propyl phosphoramide and the different flame retardant is melamine.

12. A resin containing a flame retardant-effective amount of at least one phosphoramide of claim 1.

13. A resin containing a flame retardant-effective amount of the flame retardant composition of claim 8.

14-16. (canceled)

17. The resin of claim 12 which is a polyurethane foam.

18. The resin of claim 13 which is a polyurethane foam.

19-21. (canceled)

22. A polyurethane foam-forming reaction mixture which comprises:
a) polyol;
b) phosphoramide of claim 1;
c) polyisocyanate; and, optionally,
d) at least one different flame retardant,
the total amount of (b) and (d) in the reaction mixture constituting a fire retardant effective amount in the foam obtained therefrom.

23. The reaction mixture of claim 22 wherein polyol (a) is a polyether polyol or polyester polyol.

24. The reaction mixture of claim 22 wherein polyol (a) is a polyether diol or polyester diol and polyisocyanate (c) is a diisocyanate.

25. The reaction mixture of claim 22 wherein the different flame retardant is at least one member selected from the group consisting of organohalogen compound, organophosphorus compound and melamine compound.

26. The reaction mixture of claim 22 wherein the phosphoramide is cyclic neopentyl N-propyl phosphoramide and the different flame retardant is melamine.

27. The foam obtained from the polyurethane foam-forming reaction mixture of claim 22.

28-31. (canceled)
